(19) United States
(12) Patent Application Publication
(10) Pub. No.: US 2026/0316453 A1
(43) Pub. Date: Oct. 15, 2026

(54) RECORDING DEVICE

(71) Applicant: SEIKO EPSON CORPORATION, TOKYO (JP)

(72) Inventors: Tatsuya SHIRANE, Shiojiri-shi (JP); Kohei KOZAKI, SHIOJIRI-SHI (JP); Yoshiyuki OKAZAWA, SHIOJIRI-SHI (JP); Taro TAKEKOSHI, SHIOJIRI-SHI (JP)

(21) Appl. No.: 19/644,109

(22) Filed: Apr. 10, 2026

(30) Foreign Application Priority Data
Apr. 10, 2025 (JP) 2025-064819

(51) Int. Cl. B41J 2/17; B41J 29/13

(52) U.S. Cl. CPC B41J 2/1721; B41J 29/13

(57) ABSTRACT

A recording device 1 includes a recording section 2, a liquid container 4, a housing 5, and an opening and closing body 6 that is openable and closable with respect to the housing 5, wherein the liquid container 4 is provided so as to be removable by being slid in a removal direction with respect to the housing 5, the opening and closing body 6 has a support section 8 supported in the opened position, when viewed from a removal direction A1, the liquid container 4 overlaps the support section 8 when the opening and closing body 6 is located in the closed position, and the recording section 2 does not overlap the support section 8 when the opening and closing body is located in the closed position.

The present application is based on, and claims priority from JP Application Serial Number 2025-064819, filed April 10, 2025, the disclosure of which is hereby incorporated by reference herein in its entirety.

### BACKGROUND

### 1. Technical Field

The present disclosure relates to a recording device.

### 2. Related Art

Various recording devices have been used. Among these, there is a recording device including a recording section that performs recording on a medium while moving and an opening and closing body that can be opened and closed with respect to a housing. For example, JP-A-2025-12163 discloses the recording device that is capable of performing recording on a medium while moving a carriage on which a recording unit is mounted and includes a scanner section that can be opened and closed with respect to a housing. The recording device of JP-A-2025-12163 is configured with a stay, as a support section that supports a scanner section, disposed at a position overlapping a movement region of a carriage on which a recording unit is mounted when viewed from a width direction.

In a recording device including a recording section that is configured to perform recording on a medium while moving and an opening and closing body that can be opened and closed with respect to a housing, the width of the recording device is set based on a length necessary for movement of the recording section, such as a movement region of a carriage. However, as in the recording device of JP 2025-12163, when the support section is provided at a position overlapping the movement region of the carriage when viewed from the width direction, the recording device may increase in size in the width direction.

### SUMMARY

A recording device that solves above problems includes a recording section that is configured to perform recording on a medium by moving in a first direction in a movement region; a liquid container that stores liquid; a housing that is configured to accommodate the recording section and the liquid container; and an opening and closing body that is openable and closable with respect to the housing by a distal end side thereof rotating between an opened position and a closed position with a pivot shaft having an axial direction in the first direction as a proximal end side and that covers the inside of the housing while in the closed position, wherein the liquid container is configured to be removable by being slid with respect to the housing in a removal direction along the first direction, the opening and closing body includes a support section that supports the opening and closing body in the opened position, when the opening and closing body is located in the closed position, the liquid container overlaps the support section when viewed from the first direction, and when the opening and closing body is located in the closed position, the recording section does not overlap the support section when viewed from the first direction.

### BRIEF DESCRIPTION OF THE DRAWINGS

FIG. 1 is a perspective view of a recording device according to a first embodiment of the present disclosure, and illustrates a state in which a scanner unit as an opening and closing body is located in a closed position.

FIG. 2 is a perspective view of the recording device of FIG. 1, and is a view illustrating a state in which the scanner unit is positioned in an opened position from the state of FIG. 1 and a maintenance cover as a restriction section is in a restriction position.

FIG. 3 is a perspective view of the recording device in FIG. 1, illustrating a state where the maintenance cover has moved to a nonrestriction position from the state in FIG. 2.

FIG. 4 is a perspective view of the recording device of FIG. 1, and is a view illustrating a state in which a liquid container slides in a removal direction from a fixed position to a removal position from the state of FIG. 3.

FIG. 5 is a perspective view of the recording device of FIG. 1, and is a diagram illustrating a state in which the liquid container is removed from the housing from the state of FIG. 4.

FIG. 6 is a side view illustrating the inside of the housing of the recording device in FIG. 1.

FIG. 7 is a perspective view of the recording device of FIG. 1 in the same state as that of FIG. 2, as viewed from an angle different from that of FIG. 2.

FIG. 8 is a front view illustrating the inside of the housing of the recording device in FIG. 1, and is a diagram illustrating an intermediate state in which the scanner unit is being moved from the opened position to the closed position.

FIG. 9 is a front view illustrating the inside of the housing of the recording device in FIG. 1, and is a diagram illustrating a state in which the scanner unit is moved to the closed position from the state in FIG. 8.

FIG. 10 is a perspective view illustrating the maintenance cover of the recording device of FIG. 1.

FIG. 11 is a perspective view illustrating a maintenance cover holding section that holds the maintenance cover of the recording device in FIG. 1.

FIG. 12 is a front sectional view illustrating the maintenance cover and the maintenance cover holding section of the recording device of FIG. 1, and illustrates a state where the maintenance cover is in the nonrestriction position.

FIG. 13 is a front sectional view illustrating the maintenance cover and the maintenance cover holding section of the recording device in FIG. 1, and illustrates a state where the maintenance cover is in the restriction position.

FIG. 14 is a front view illustrating the inside of the housing of the recording device according to a second embodiment of the present disclosure, and illustrates an intermediate state in which the scanner unit is being moved from the opened position to the closed position.

FIG. 15 is a perspective view of the recording device of FIG. 14, and is a diagram illustrating a state in which the scanner unit is positioned in the opened position from the state of FIG. 14, and a state in which the liquid container is in a fixed position.

FIG. 16 is a perspective view of the recording device of FIG. 14, and is a view illustrating a state in which the liquid container slides in the removal direction from the fixed position to the removal position from the state of FIG. 15.

FIG. 17 is a perspective view of the recording device of FIG. 14 and is a diagram illustrating a state in which the liquid container is removed from the housing from the state of FIG. 16.

FIG. 18 is a perspective view of a scanner unit as the opening and closing body of the recording device of FIG. 14.

FIG. 19 is a front view illustrating the inside of the housing of the recording device in FIG. 14, illustrating the restriction section and the positioning sections an exaggerated manner, and illustrating a state in which the upper cover is positioned in a closed position.

FIG. 20 is a front view illustrating the inside of the housing of the recording device of FIG. 14 and is a diagram illustrating a state where an upper cover is positioned in the opened position.

FIG. 21 is a perspective view of the upper cover as the opening and closing body of the recording device according to a third embodiment of the present disclosure.

### DESCRIPTION OF EMBODIMENTS

The present disclosure will be schematically described below.

A recording device according to a first aspect of the disclosure includes a recording section that is configured to perform recording on a medium by moving in a first direction in a movement region; a liquid container that stores liquid; a housing that is configured to accommodate the recording section and the liquid container; and an opening and closing body that is openable and closable with respect to the housing by a distal end side thereof rotating between an opened position and a closed position with a pivot shaft having an axial direction in the first direction as a proximal end side and that covers the inside of the housing while in the closed position, wherein the liquid container is configured to be removable by being slid with respect to the housing in a removal direction along the first direction, the opening and closing body includes a support section that supports the opening and closing body in the opened position, when the opening and closing body is located in the closed position, the liquid container overlaps the support section when viewed from the first direction, and when the opening and closing body is located in the closed position, the recording section does not overlap the support section when viewed from the first direction.

When the support section is provided at a position overlapping the movement region of the recording section when viewed from the first direction, the recording device may increase in size in the first direction, but according to present aspect, the recording section does not overlap the support section when viewed from the first direction when the opening and closing body is positioned ing the closed position. With such a configuration, it is not necessary to make the size of the recording device in the first direction larger than the movement region of the recording section, and the recording device can be downsized.

A recording device according to a second aspect of the disclosure is the recording device according to an aspect dependent on the first aspect, wherein the support section is located further to the distal end side than the movement region in a direction from the proximal end side toward the distal end side when the opening and closing body is located in the closed position.

According to the present aspect, the support section is located on the distal end side with respect to the movement region in the direction from the proximal end side toward the distal end side when the opening and closing body is located in the closed position. With such a configuration, the support section is configured to support the opening and closing body with a small force, and the support section can suppress being damaged.

A recording device according to a third aspect of the disclosure is a recording apparatus according to an aspect dependent on the first or second aspect, wherein the housing includes a restriction section that is provided so as to be movable to a restriction position and a nonrestriction position and that restricts movement of the liquid container in the removal direction while in the restriction position, the opening and closing body includes a protruding section that is contactable with the restriction section, and the restriction section is pushed by the protruding section and moves to the restriction position when the opening and closing body moves from the opened position to the closed position.

According to the present aspect, the opening and closing body includes the protruding section configured to come into contact with the restriction section, and the restriction section is pushed by the protruding section and moves to the restriction position when the opening and closing body moves from the opened position to the closed position. With such a configuration, the restriction section is configured to suitably moved to the restriction position by closing the opening and closing body, and it is possible to suppress a state in which the restriction section is not in the restriction position in a state in which the opening and closing body is in the closed position.

A recording device according to a fourth aspect of the disclosure is a recording device according to an aspect dependent on the third aspect, wherein the protruding section fixes the restriction section in the restriction position by contacting the restriction section in a state where the opening and closing body is located in the closed position.

According to the present aspect, the protruding section fixes the restriction section in the restriction position by contacting with the restriction section in a state where the opening and closing body is located in the closed position. With such a configuration, in a state where the opening and closing body is in the closed position, the restriction section is fixed in the restriction position, and the restriction section is configured to suitably restrict the movement of the liquid container in the removal direction.

A recording device according to a fifth aspect of the disclosure is a recording device according to an aspect dependent on the third or fourth aspect, wherein when the opening and closing body moves from the opened position to the closed position, the restriction section presses the liquid container in a fixing direction opposite to the removal direction.

According to the present aspect, the restriction section presses, when the opening and closing body moves from the opened position to the closed position, the restriction section presses the liquid container in the fixing direction opposite to the removal direction. With such a configuration, it is possible to suppress the liquid container from moving in the removal direction in a state where the opening and closing body is in the closed position.

A recording device according to a sixth aspect of the disclosure is a recording device according to an aspect dependent on any one of the first to fifth aspects, wherein

the opening and closing body includes a restriction section that restricts movement of the liquid container in the removal direction in the closed position.

According to present aspect, the opening and closing body includes the restriction section that restricts the movement of the liquid container in the removal direction in the closed position. With such a configuration, for example, the restriction section can be suitably moved to the restriction position by closing the opening and closing body, and it is possible to suppress the restriction section from not being located in the restriction position in a state where the opening and closing body is located in the closed position.

A recording device according to a seventh aspect of the disclosure is a recording device according to an aspect dependent on the sixth aspect, wherein the restriction section comes into contact with the liquid container in a state in which the opening and closing body is in an intermediate state accompanying movement from the opened position to the closed position, and moves the liquid container in a fixing direction opposite to the removal direction while pressing the liquid container as the opening and closing body moves to the closed position while coming into contact with the liquid container.

According to present aspect, the restriction section comes into contact with the liquid container in a state in which the opening and closing body is in the intermediate state accompanying movement from the opened position to the closed position, and moves the liquid container in the fixing direction opposite to the removal direction while pressing the liquid container as the opening and closing body moves to the closed position while coming into contact with the liquid container. With such a configuration, it is possible to suppress the liquid container from moving in the removal direction in a state where the opening and closing body is in the closed position, and it is possible to detach the liquid container only by two operations of the operation of opening the opening and closing body and the operation of detaching the liquid container.

A recording device according to an eighth aspect of the disclosure is a recording device according to an aspect dependent on the first or second aspect, wherein a restriction section configured to restrict movement of the liquid container in the removal direction, wherein the restriction section includes a pressing section that is configured to press the liquid container in a fixing direction opposite to the removal direction.

According to present aspect, the opening and closing body is configured to include the restriction section that restricts the movement of the liquid container in the removal direction, the restriction section including the pressing section configured to press the liquid container in the fixing direction opposite to the removal direction. With such a configuration, it is possible to suppress the liquid container from moving in the removal direction in a state where the opening and closing body is in the closed position.

A recording device according to a ninth aspect of the disclosure is a recording device according to an aspect which depends on any one of the first to eighth aspects, wherein the opening and closing body includes a positioning section configured to perform positioning in the first direction with respect to the housing, the housing includes a positioned section configured to be fitted into the positioning section when the opening and closing body is located in the closed position, and the positioned section is positioned further to the distal end side than the movement region in a direction from the proximal end side toward the distal end side when the opening and closing body is positioned in the closed position.

According to the present aspect, the opening and closing body includes the positioning sections that perform positioning in the first direction with respect to the housing, the housing includes the positioned sections that is fitted to the positioning sections in a state where the opening and closing body is located in the closed position, and the positioned sections are located at the distal end side with respect to the movement region in the direction from the proximal end side toward the distal end side in a case where the opening and closing body is located at the closed position. With such a configuration, it is possible to reduce wobbling of the opening and closing body with respect to the housing due to variation in the positional relationship between the opening and closing body and the housing.

A recording device according to a tenth aspect of the disclosure is a recording device according to an aspect dependent on the ninth aspect, wherein a restriction section configured to restrict movement of the liquid container in the removal direction, wherein the positioned section overlaps the restriction section when viewed from the first direction.

According to present aspect, the opening and closing body includes the restriction section that restricts the movement of the liquid container in the removal direction is provided, and the positioned sections overlap the restriction section when viewed from the first direction. With such a configuration, it is possible to reduce the region occupied by the positioned sections and the restriction section when viewed from the first direction, and it is possible to suitably reduce the size of the recording device.

A recording device according to an eleventh aspect of the disclosure is a recording device according to an aspect dependent on the tenth aspect, wherein the housing includes a restriction section holding section that has a recessed shape into which the restriction section having a protruding shape is configured to enter when the opening and closing body is located in the closed position and a first length, which is a length by which the positioned holding section and the positioning section overlap each other when viewed from the first direction, is longer than a second length, which is a length by which the restriction section holding section and the restriction section overlap each other when viewed from the first direction.

According to the present aspect, the first length, which is the length by which the positioned sections and the positioning sections overlap each other when viewed from the first direction, is longer than the second length, which is the length by which the restriction holding section and the restriction section holding section overlap each other when viewed from the first direction. With such a configuration, the restriction section holding section and the restriction section are configured to be particularly suitably positioned, and variations in the positional relationship between the restriction section and the liquid container is configured to be suitably reduced.

A recording device according to a twelfth aspect of the disclosure is a recording device according to an aspect dependent on the tenth or eleventh aspect, wherein the housing includes a restriction section holding section that has a recessed shape into which the restriction section having a protruding shape is configured to enter when the opening and closing body is located in the closed position and the opening and closing body is configured such that, as the opening and closing body moves from the opened position to the closed position, the restriction section enters the restriction section holding section after the positioning section starts to enter the positioned section.

According to present aspect, the restriction section is configured to start to enter the restriction section holding section after the positioning sections start to enter the positioned sections as the opening and closing body moves from the opened position to the closed position. With this configuration, the positioning sections comes into contact with the positioned positions first and are positioned, and thus it is possible to suitably reduce variation in the positional relationship between the restriction section and the liquid container.

A recording device according to a thirteenth aspect of the disclosure is a recording device according to an aspect dependent on any one of the first to twelfth aspects, wherein the liquid container is configured to enter a support section holding region, in which the support section is located when the opening and closing body is located in the closed position, by being slid in the removal direction in accordance with movement of the opening and closing body from the closed position to the opened position and with movement of the support section from the support section holding region.

According to present aspect, the liquid container is configured to enter the support section holding region in which the support portion is located in a state where the opening and closing body is located at the closed position by being slid in the removal direction as the opening and closing body moves from the closed position to the opened position and the support section moves from the support section holding region. With such a configuration, the support section holding region is configured to be used as both the arrangement position of the support section and the arrangement position of the liquid container, and the space in the housing is configured to be effectively used, so that the recording device is suitably miniaturized.

A recording device according to a fourteenth aspect of the disclosure is a recording device according to an aspect dependent on any one of the first to thirteenth aspects, wherein in an aspect dependent on any one of the first to thirteenth aspects, the liquid container is a waste liquid recovery section, the housing includes an insertion section that is inserted into the waste liquid recovery section, and the insertion section is inserted into the waste liquid recovery section as the opening and closing body is moved from the opened position to the closed position.

According to present aspect, the liquid container is the waste liquid recovery section, the housing has the insertion section that is inserted into the waste liquid recovery section, and the insertion section is inserted into the waste liquid recovery section as the opening and closing body is moved from the opened position to the closed position. With such a configuration, the waste liquid recovery section is configured to be inserted into the insertion section and fixed in accordance with the closing operation of the opening and closing body, and the insertion section is configured to be easily prevented from coming off from the waste liquid recovery section in a state where the opening and closing body is located in the closed position.

### FIRST EMBODIMENT

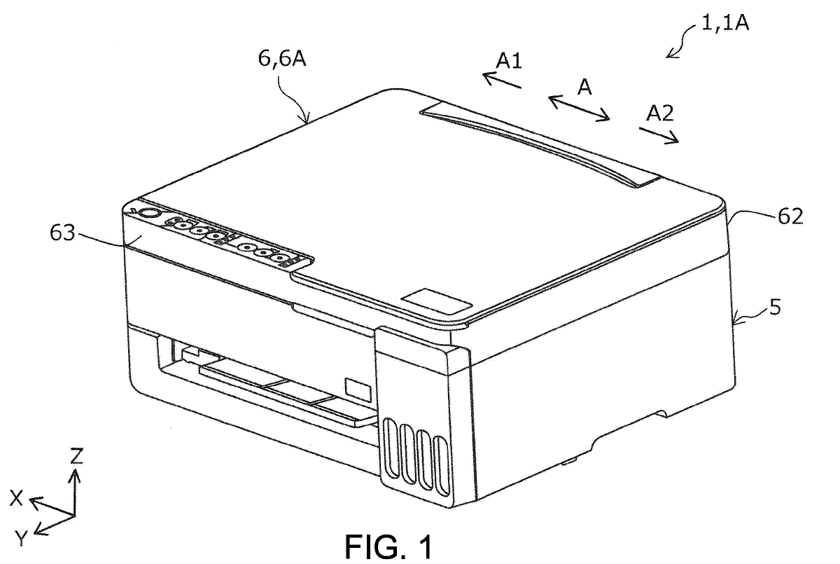

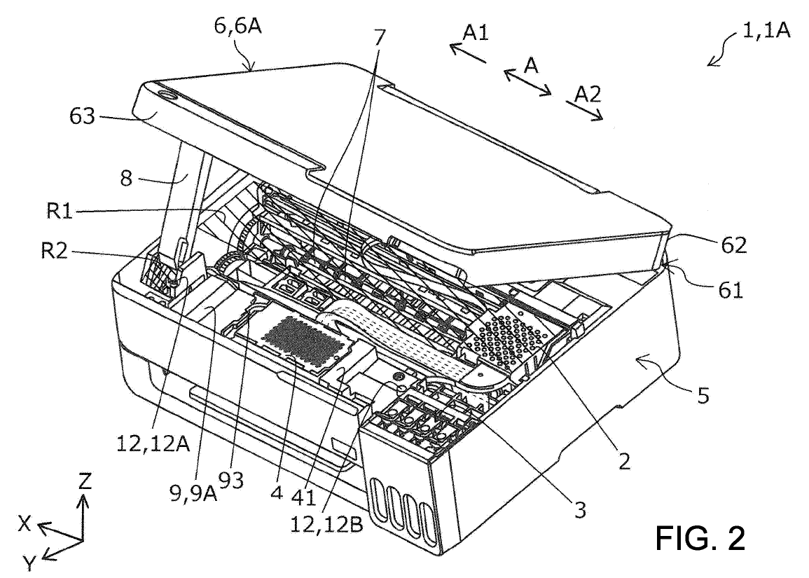

Hereinafter, the present disclosure will be described in detail. First, an overview of a recording device 1A of a first embodiment, which is an example of a recording device 1, will be described with reference to FIGS. 1 and 2. In the X-Y-Z coordinate system illustrated in each drawing, an X-axis direction is the side direction of the device, that is, the width direction, a Y-axis direction is the front direction and the back direction of the device, and a Z-axis direction is the height direction and the gravity direction of the device. Specifically, the +Y direction is the front direction, the -Y direction is the back direction, the +Z direction is the upward direction, and the -Z direction is the downward direction. In each drawing, some constituent members may be omitted or simplified for easy understanding of the internal configuration and the like.

As illustrated in FIG. 2 and the like, the recording device 1A of the present embodiment includes a recording section 2 for recording on a medium by ejecting ink, which is a liquid. The recording device 1 includes an ink accommodation section 3 that stores ink, and a waste liquid recovery section 4 as the liquid container capable of storing liquid by collecting waste liquid generated during recording. Further, the recording device 1 includes a housing 5 that houses the recording section 2, the ink accommodation section 3, the waste liquid recovery section 4, and a scanner unit 6A on the +Z direction side, which is the upper portion of the housing 5.

As illustrated in FIG. 2, the recording section 2 is configured to perform recording by ejecting ink onto the medium transported by the transport section 7 by moving in a first direction A along the X-axis direction in the movement region R1. In the scanner unit 6A, the distal end 63 side can be rotated to an opened position as illustrated in FIGS. 2 to 5 and the like and a closed position as illustrated in FIGS. 1 to 6, and the like with a pivot shaft 61 that has the first direction A as an axial direction as a proximal end 62 side. That is, the scanner unit 6A is an opening and closing body 6 that is provided so as to be openable and closable with respect to the housing 5 and covers the inside of the housing 5 in the closed position.

Here, the waste liquid recovery section 4 as a liquid container is provided so as to be removable by being slid in a removal direction A1 along the first direction A with respect to the housing 5. Hereinafter, a procedure for removing the waste liquid recovery section 4 from the housing 5 will be described with reference to FIGS. 1 to 5.

When the waste liquid recovery section 4 is removed from the housing 5, the user first rotates the scanner unit 6A with the pivot shaft 61 as a reference so that the scanner unit 6A is in the opened position illustrated in FIG. 2 from the state in which the scanner unit 6A is in the closed position illustrated in FIG. 1. Here, the recording device 1A in the present embodiment includes, as illustrated in FIGS. 2 to 5, a support section 8 configured to support the scanner unit 6A so that the scanner unit 6A can maintain the opened position.

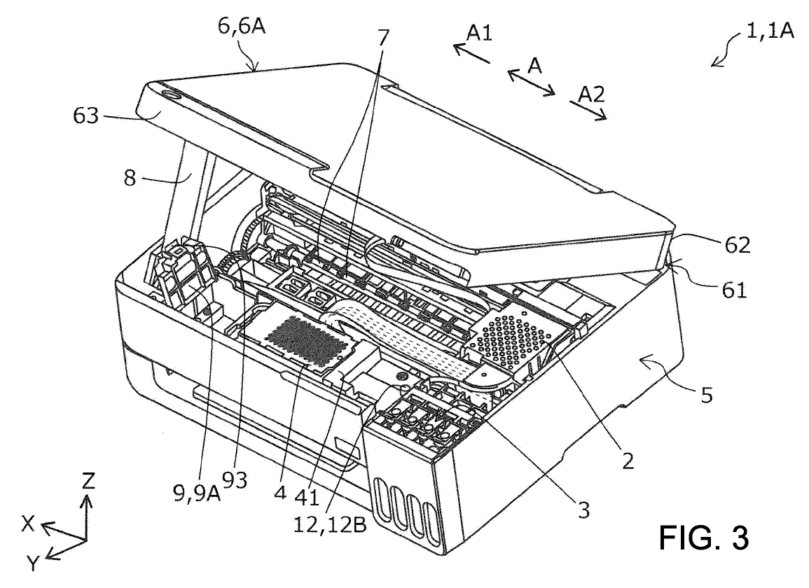

The recording device 1A in the present embodiment is, as illustrated in FIGS. 2 to 5, provided with a maintenance cover 9A in the housing 5. The maintenance cover 9A is provided so as to be movable, that is, rotatable between a restriction position illustrated in FIG. 2 and a nonrestriction position illustrated in FIGS. 3 to 5. The maintenance cover 9A serves as a restriction section 9 that regulates the movement of the waste liquid recovery section 4 to the removal direction A1 in the removing direction in the restriction position.

It should be noted that in a state where the scanner unit 6A is in the closed position as illustrated in FIG. 1, the maintenance cover 9A is located in the restriction position. The user can rotate the scanner unit 6A from the closed position illustrated in FIG. 1 to the opened position illustrated in FIG. 2. The maintenance cover 9A is configured to be moved from the state where the maintenance cover 9A is located in the restriction position as illustrated in FIG. 2 to the state where the maintenance cover 9A is located in the nonrestriction position as illustrated in FIG. 3. In the recording device 1A of the present embodiment, the user manually rotates the scanner unit 6A and the maintenance cover 9A. However, the present embodiment is not limited to such a configuration, and a configuration may be adopted in which the maintenance cover 9A automatically moves from the restriction position to the nonrestriction position by, for example, a spring pressure of a coil spring or the like in accordance with the user rotating the scanner unit 6A from the closed position to the opened position.

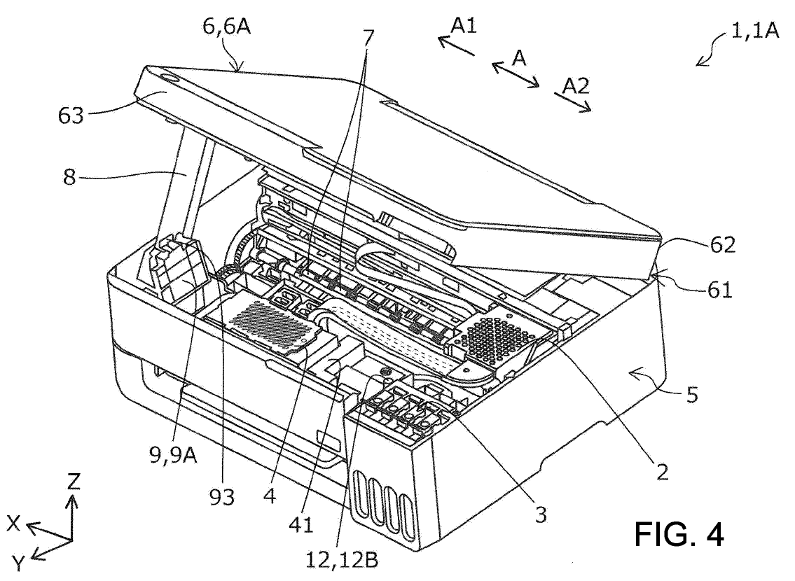

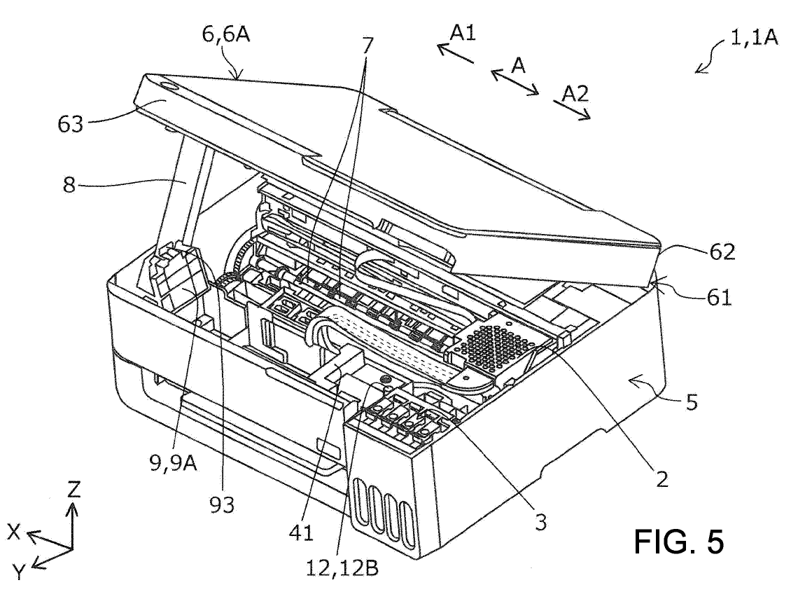

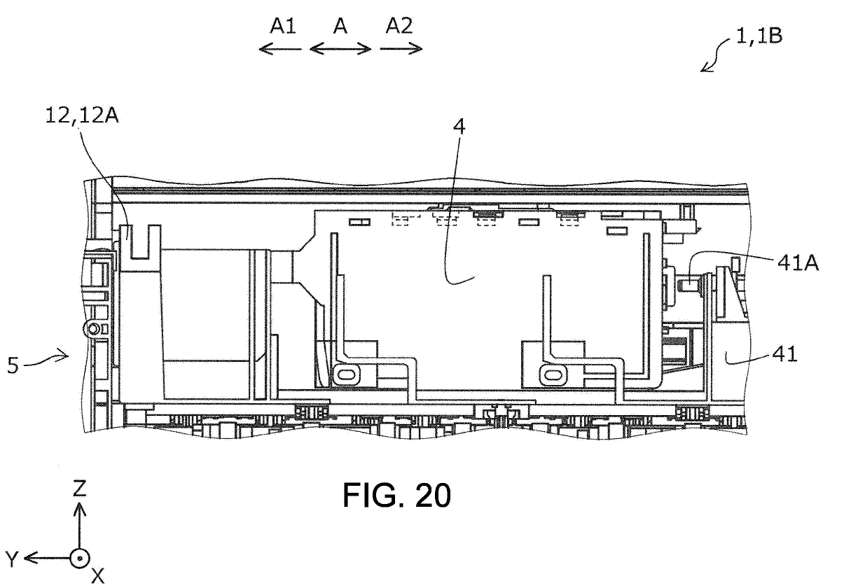

In the recording device 1A of the present embodiment, when the maintenance cover 9A is moved to the nonrestriction position as illustrated in FIG. 3, the user moves the waste liquid recovery section 4 toward the removal direction A1 as illustrated in FIG. 4. In the state illustrated in FIG. 4, the insertion of the waste liquid recovery section 4 in the insertion section 41, which has an insertion needle 41A (not illustrated) in the present embodiment (see the insertion needle 41A in FIG. 20, which has the same shape as that in the present embodiment) is released, and the user can detach the waste liquid recovery section 4 from the housing 5 as illustrated in FIG. 5. On the other hand, for example, an elastic member such as a spring may be provided, and the waste liquid recovery section 4 may be configured to automatically move to the removal direction A1 when the maintenance cover 9A moves to the nonrestriction position.

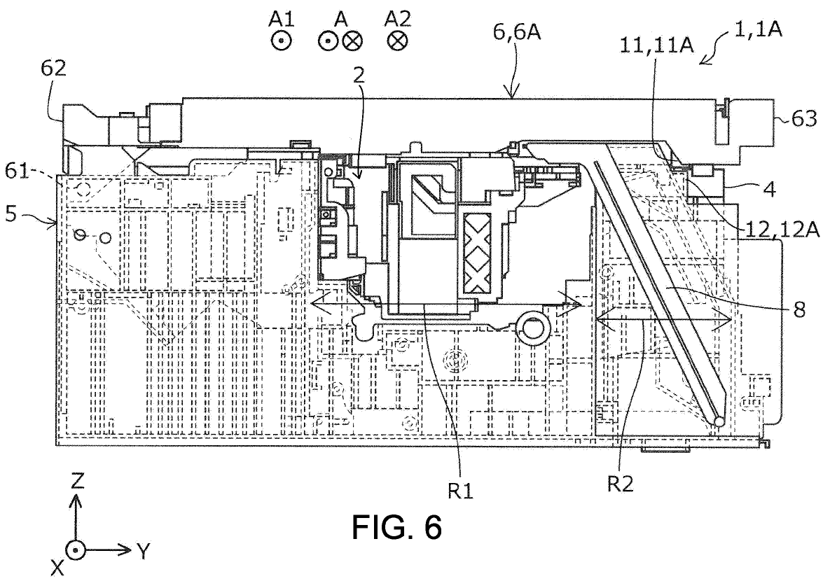

Next, with reference to FIG. 6, a positional relationship between the support section 8 and the waste liquid recovery section 4 and a positional relationship between the support section 8 and the recording section 2 will be described. In the recording device 1A of the present embodiment, as illustrated in FIG. 6, the waste liquid recovery section 4 is disposed at a position overlapping the support section 8 when viewed from the first direction A when the scanner unit 6A is positioned in the closed position. On the other hand, in the recording device 1A of the present embodiment, as illustrated in FIG. 6, the recording section 2 is disposed at a position that does not overlap the support section 8 when viewed from the first direction A when the scanner unit 6A is positioned in the closed position.

When the support section 8 is provided at a position overlapping the movement region R1 of the recording section 2 when viewed from the first direction A, there is a concern that the recording device 1 increases in size in the first direction A, but in the recording device 1A of the present embodiment, the recording section 2 does not overlap the support section 8 when viewed from the first direction A in a case where the scanner unit 6A is positioned in the closed position. Since the recording device 1A of the present embodiment has such a configuration, it is not necessary to make the size of the recording device 1 in the first direction A larger than the movement region R1 of the recording section 2, and thus, it is possible to reduce the size of the recording device 1.

In the recording device 1A according to the present embodiment, as illustrated in FIG. 6, when the scanner unit 6A is located in the closed position, the support section 8 is located further toward the distal end 63 side than the movement region R1 of the recording section 2 in the +Y direction from the proximal end 62 side toward the distal end 63 side. With such a configuration, the support section 8 8 is configured to support the scanner unit 6A with a small force, and the support section 8 is configured to be prevented from being damaged. When the scanner unit 6A is positioned in the closed position, the waste liquid recovery section 4 is disposed at a position overlapping the support section 8 when viewed from the first direction A, and with such a configuration, and also by disposing the support section 8 and the waste liquid recovery section 4 in the +Y direction, the waste liquid recovery section 4 is easily attached and detached.

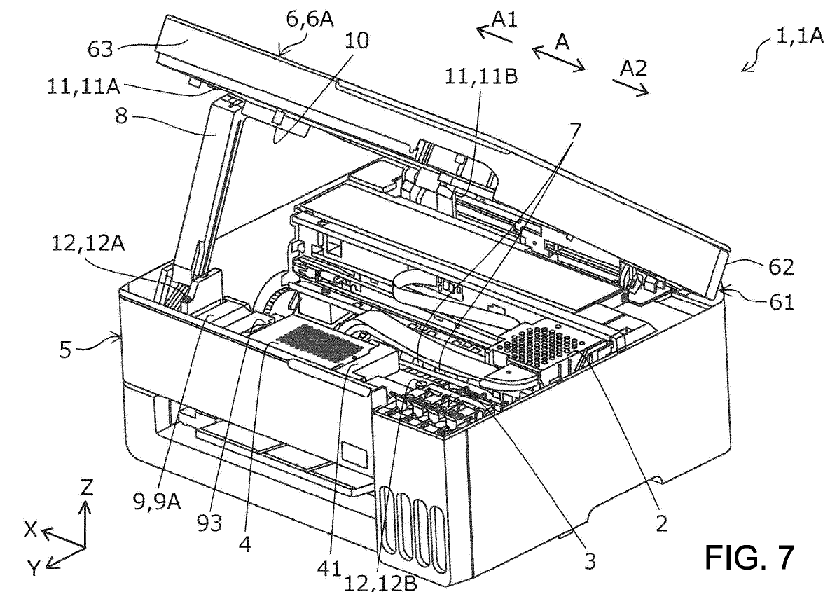

As described above, in the recording device 1A of the present embodiment, the maintenance cover 9A is manually moved to the nonrestriction position by the user after the scanner unit 6A is rotated from the closed position to the opened position. On the other hand, the recording device 1A of the present embodiment is configured such that, when the scanner unit 6A is rotated from the opened position to the closed position, the maintenance cover 9A is automatically and reliably moved to the restriction position. The mechanism will be described below with reference to FIGS. 7 to 9.

As described above, in the recording device 1A of the present embodiment, the housing 5 is provided to be movable to the restriction position and the nonrestriction position and includes the maintenance cover 9A as the restriction section 9 that in the restriction position regulates the movement of the waste liquid recovery section 4 in the removal direction A1. Here, as illustrated in FIG. 7, the scanner unit 6A has a protruding section 10 in the upward direction (+Z direction) of the maintenance cover 9A in a state where the scanner unit 6A is in the opened position.

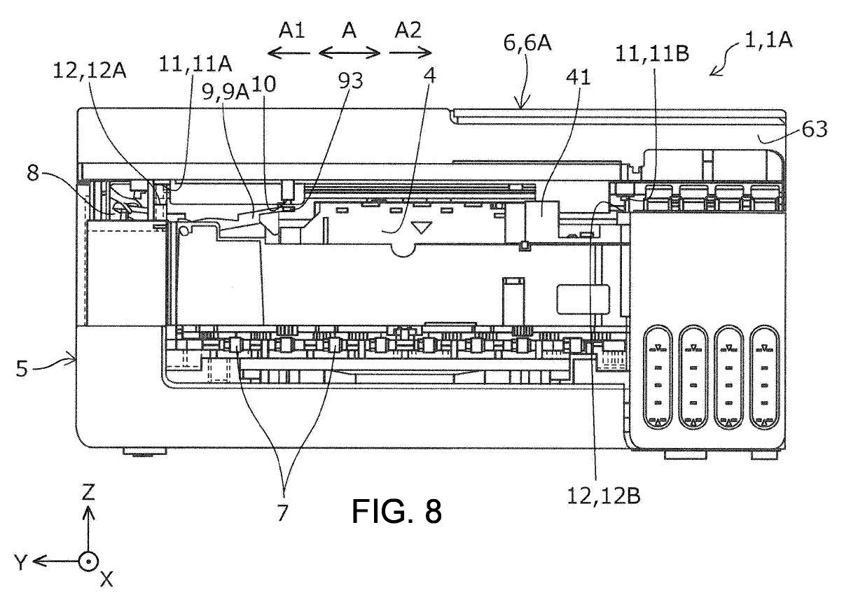

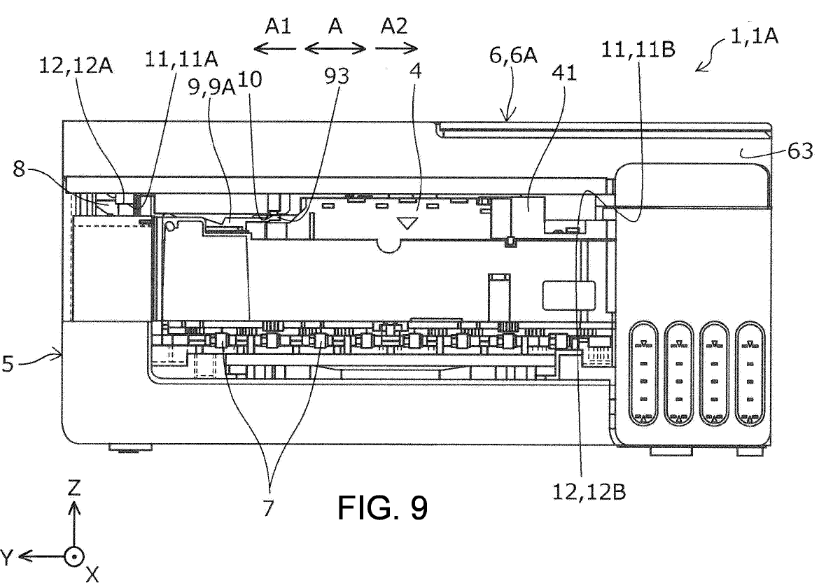

In order to change the state of the maintenance cover 9A from the nonrestriction position to the restriction position, the user rotates the maintenance cover 9A from the nonrestriction position to the restriction position. However, even by the user's operation, as illustrated in FIG. 8, the maintenance cover 9A may not be completely moved to the restriction position. In such a case, in the recording device 1A of the present embodiment, when the scanner unit 6A is rotated by the user from the state of being in the opened position to the closed position, as illustrated in FIG. 8, the contact section 93 of the maintenance cover 9A in the state of being in the nonrestriction position and the protruding section 10 come into contact with each other. When the scanner unit 6A is further rotated to the closed position in this state, as illustrated in FIG. 9, the maintenance cover 9A is pushed by the protruding section 10 and moves to the restriction position. With such a configuration, the recording device 1A of the present embodiment is configured to suitably move the maintenance cover 9A to the restriction position by closing the scanner unit 6A and is configured to suppress a state in which the maintenance cover 9A is not in the restriction position in a state in which the scanner unit 6A is in the closed position.

As illustrated in FIG. 9, the protruding section 10 comes into contact with the maintenance cover 9A in a state where the scanner unit 6A is located in the closed position, thereby fixing the maintenance cover 9A in the restriction position. By configuring the recording device 1A of the present embodiment in this manner, the maintenance cover 9A is configured to be fixed in the restriction position in a state in which the scanner unit 6A is in the closed position, and the maintenance cover 9A is configured to suitably restrict the waste liquid recovery section 4 from moving in the removal direction A1.

From another viewpoint, the maintenance cover 9A presses the waste liquid recovery section 4 in the fixing direction A2 opposite to the removal direction A1 in accordance with the movement of the scanner unit 6A from the opened position to the closed position. With such a configuration, the recording device 1A of the present embodiment is configured to suppress the waste liquid recovery section 4 from moving to the removal direction A1 in a state where the scanner unit 6A is in the closed position.

From still another viewpoint, the recording device 1A of the present embodiment has a configuration in which the housing 5 includes the insertion section 41 inserted into the waste liquid recovery section 4, and the insertion section 41 is inserted into the waste liquid recovery section 4 as the scanner unit 6A is moved from the opened position to the closed position. With such a configuration, the waste liquid recovery section 4 is configured to be inserted into and fixed to the insertion section 41 in accordance with the closing operation of the scanner unit 6A, and it is possible to suppress the leakage of the waste liquid due to the insertion needle 41A of the insertion section 41 coming off from the waste liquid recovery section 4 in a state where the scanner unit 6A is located in the closed position.

It should be noted that in the recording device 1A of the present embodiment, in order to position the scanner unit 6A and the housing 5 when the scanner unit 6A is moved from the opened position to the closed position, positioning sections 11 that have a protruding shape are provided on the scanner unit 6A, and positioned sections 12 that have a recessed shape into which the positioning sections 11 enter are provided on the housing 5. To be specific, as illustrated in FIGS. 7 and 8, the scanner unit 6A is provided with a positioning section 11A and a positioning section 11B, and the housing 5 is provided with a positioned section 12A into which enters the positioning section 11A and a positioned section 12B into which enters the positioning section 11B. It should be noted that in the present embodiment, the positioning sections 11, which have a protruding shape, are provided on the scanner unit 6A and the positioned sections 12, which have a recessed shape, are provided on the housing 5, but the present embodiment is not limited to such a configuration, and positioning sections 11 that have a recessed shape may be provided on the scanner unit 6A and positioned sections 12 that have a protruding shape may be provided on the housing 5.

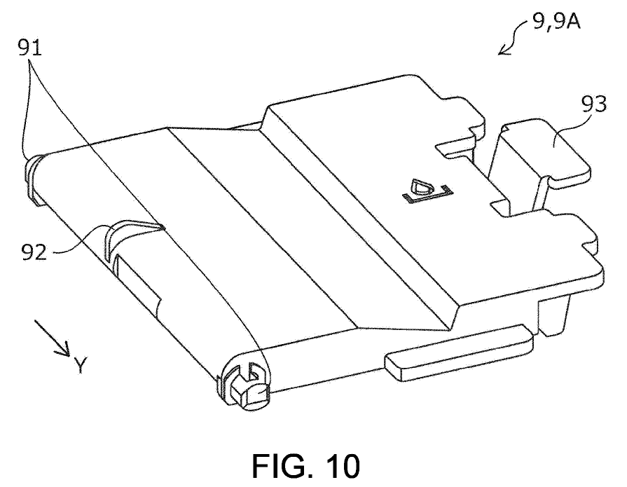

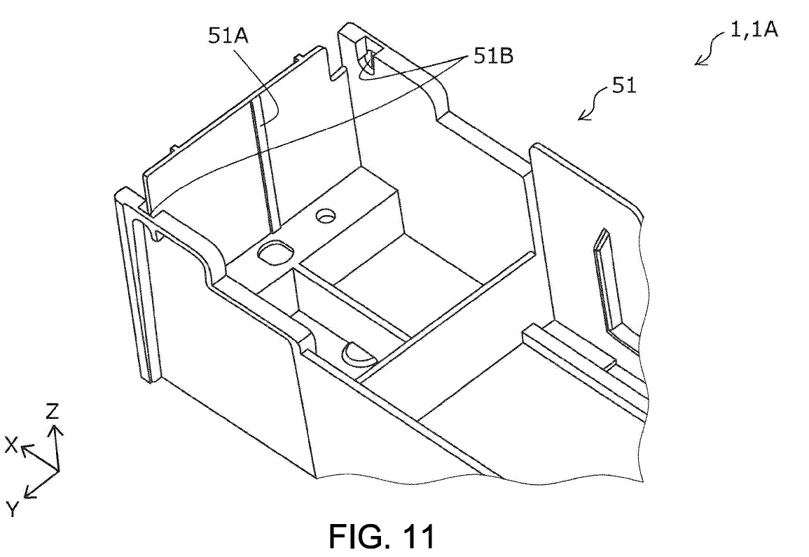

Here, a more detailed configuration of the maintenance cover 9A will be described with reference to FIGS. 10 to 13. As illustrated in FIG. 10, the maintenance cover 9A includes a protrusion 91 constituting the pivot shaft and a cam 92 in addition to a contact section 93 that comes into contact with the protruding section 10. The contact section 93 also serves as a grip section that can be gripped by a user when the user moves the maintenance cover 9A from the restriction position to the nonrestriction position. The protrusion 91 is held by a protrusion holding section 51B of the maintenance cover holding section 51 illustrated in FIG. 11, and the protrusion 91 and the protrusion holding section 51B constitute the pivot shaft. The protrusion 91 is held by the protrusion holding section 51B, so that the cam 92 is disposed in a position where the cam 92 can contact the cam sliding section 51A of the maintenance cover holding section 51. It should be noted that the maintenance cover holding section 51 is provided in the housing 5.

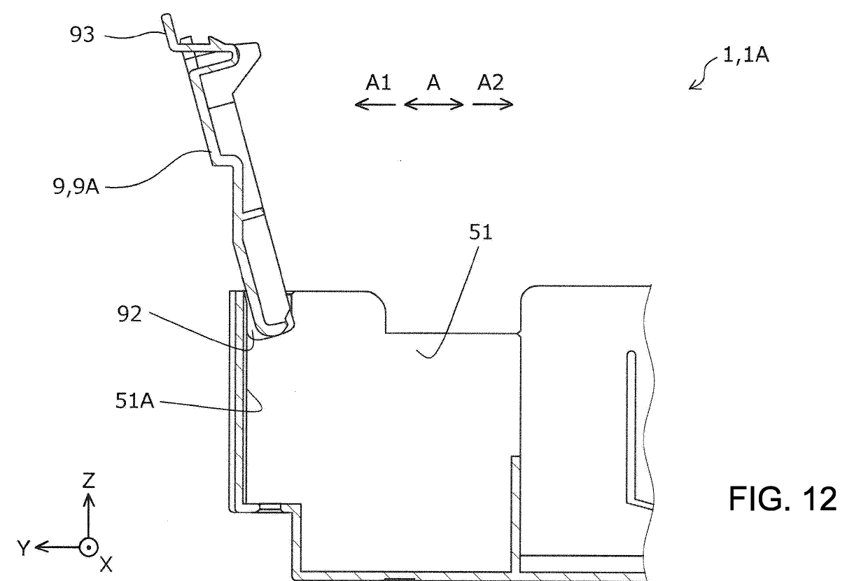

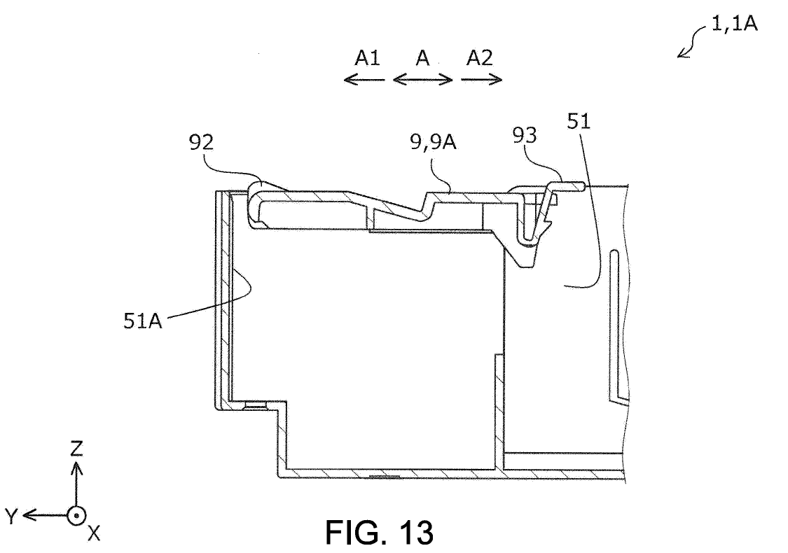

The maintenance cover 9A is held by the maintenance cover holding section 51 with the above-described configuration, and is configured to be movable between a nonrestriction position illustrated in FIG. 12 and a restriction position illustrated in FIG. 13. As illustrated in FIG. 12, in the nonrestriction position, the cam 92 of the maintenance cover 9A is disposed in contact with the cam sliding section 51A of the maintenance cover holding section 51. Here, the cam 92 contacts the cam sliding section 51A in the nonrestriction position, so that it is possible to suppress the maintenance cover 9A from being closed by its own weight or the like when the user does not intend it to do so. On the other hand, as illustrated in FIG. 13, in the restriction position, the cam 92 of the maintenance cover 9A is disposed so as not to contact the cam sliding section 51A of the maintenance cover holding section 51.

It should be noted that in the recording device 1A of the present embodiment, the waste liquid recovery section 4 does not enter the support section holding region R2 illustrated in FIG. 2 where the support section 8 is located in a state where the scanner unit 6A is located in the closed position, even when the waste liquid recovery section 4 is slid in the removal direction A1 as the scanner unit 6A moves from the closed position to the opened position and the support section 8 moves upward direction (+Z direction) from the support section holding region R2. However, the waste liquid recovery section 4 may be configured to be able to enter the support section holding region R2 where the support section 8 is located in a state where the scanner unit 6A is located in the closed position by being slid in the removal direction A1 as the scanner unit 6A moves from the closed position to the opened position and the support section 8 moves from the support section holding region R2. With such a configuration, the support section holding region R2 is configured to be used as both the arrangement position of the support section 8 and the arrangement position of the waste liquid recovery section 4, and the space in the housing 5 is effectively used, whereby the recording device 1 is suitably miniaturized.

### SECOND EMBODIMENT

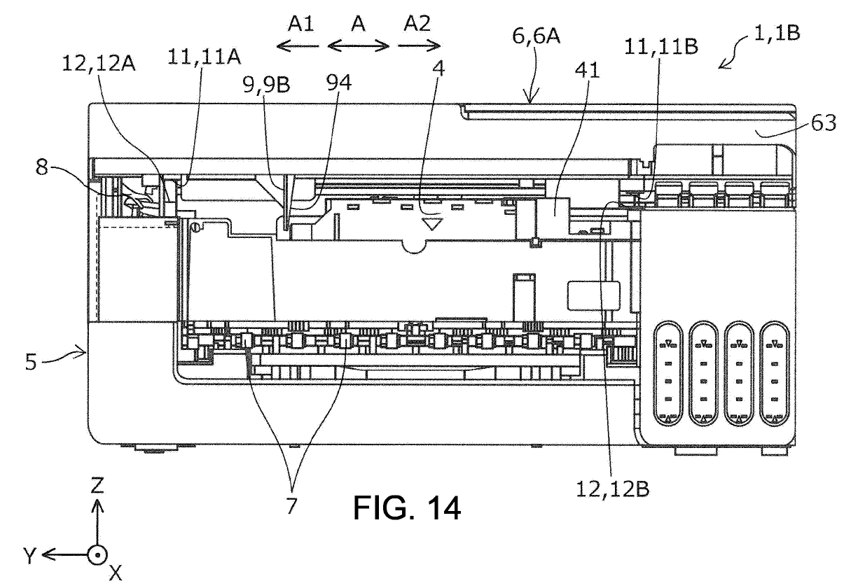

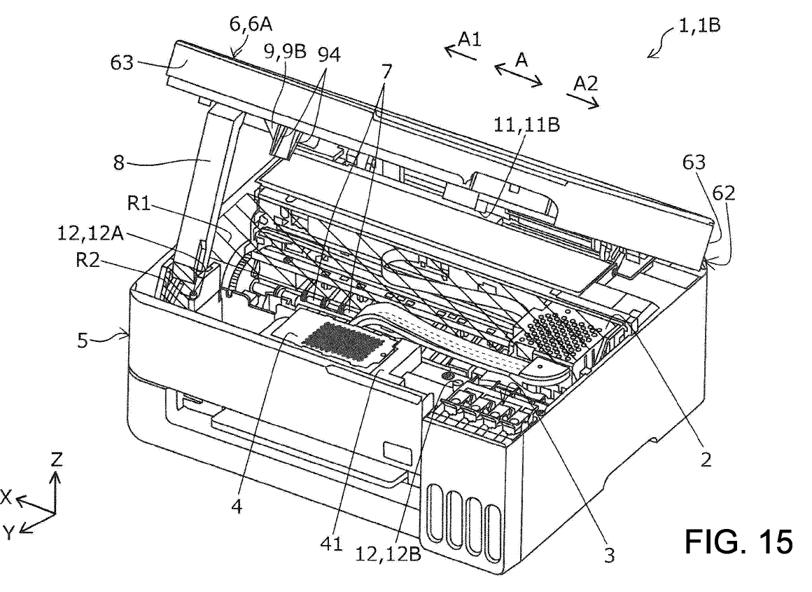

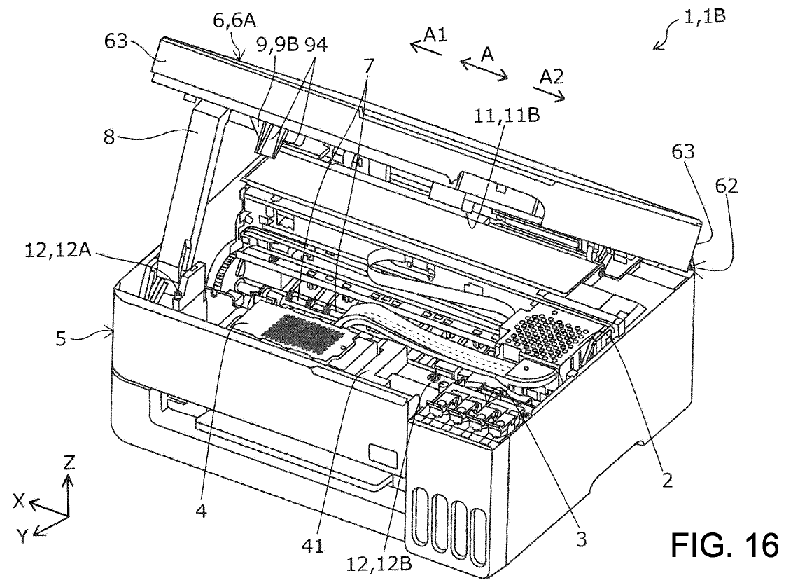

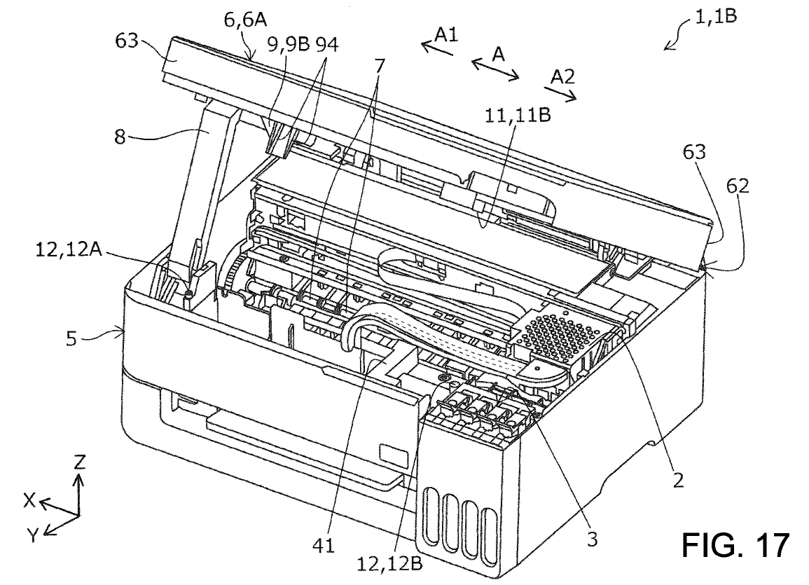

Next, a recording device 1B of a second embodiment will be described with reference to FIGS. 14 to 20. FIG. 14 corresponds to FIG. 8 of the recording device 1A of a first embodiment, FIG. 15 corresponds to FIG. 3 of the recording device 1A of the first embodiment although the viewing angle is different, FIG. 16 corresponds to FIG. 4 of the recording device 1A of the first embodiment although the viewing angle is different, and FIG. 17 corresponds to FIG. 5 of the recording device 1A of the first embodiment although the viewing angle is different. It should be noted that in FIGS. 14 to 20, the same reference numerals are given to the same constituent member as those in the first embodiment, and the detailed description thereof will be omitted. Here, the recording device 1B of the present embodiment has the same configuration as the recording device 1A of the first embodiment except for the configuration of the restriction section 9. Therefore, the recording device 1B of the present embodiment has the same features as the recording device 1A of the first embodiment except for the parts described below.

The recording device 1B of the present embodiment includes a protruding shaped restriction section 9B as the restriction section 9 on the scanner unit 6A as the opening and closing body. In other words, the scanner unit 6A includes the restriction section 9B that restricts the movement of the waste liquid recovery section 4 in the removal direction A1 in the closed position. With such a configuration, for example, the restriction section 9B is configured to be suitably moved to the restriction position by closing the scanner unit 6A, which is an opening and closing body, and is configured to suppress the restriction section 9BA from not being in the restriction position in a state where the scanner unit 6A is in the closed position.

Here, as illustrated in FIG. 14, the restriction section 9B comes into contact with the waste liquid recovery section 4 in an intermediate state accompanying movement of the scanner unit 6A from the opened position to the closed position. The restriction section 9B has an inclined surface section 94, and as the scanner unit 6A moves to the closed position while the inclined surface section 94 is in contact with the waste liquid recovery section 4, the waste liquid recovery section 4 slides with respect to the inclined surface section 94 and the waste liquid recovery section 4 is moved in the fixing direction A2 opposite to the removal direction A1 while pressing the waste liquid recovery section 4. It should be note that, as illustrated in FIG. 14 and the like, the inclined surface section 94 is an inclined surface that is inclined in the -Y direction with distance in the +Z direction in a state where the scanner unit 6A is located in the closed position.

With such a configuration, the recording device 1B of the present embodiment is configured to suppress the waste liquid recovery section 4 from wobbling inside the housing 5 and the waste liquid recovery section 4 from moving in the removal direction A1 in a state where the scanner unit 6A is in the closed position. Further, it can suppress the scanner unit 6A from entering the closed position in a state where the waste liquid recovery section 4 is not moved in the fixing direction A2, that is, in a state where the insertion needle 41A is not suitably inserted. In addition to these, for example, it is configured to omit an operation of rotating the maintenance cover 9A, which is necessary in the recording device 1A of the first embodiment, and it is configured to detach the waste liquid recovery section 4 only by the two operations of the operation of opening the scanner unit 6A and the operation of detaching the waste liquid recovery section 4.

As described above, the restriction section 9B can be regarded as a pressing section that has the inclined surface section 94, in that the inclined surface section 94 is provided and the waste liquid recovery section 4 is moved in the fixing direction A2 opposite to the removal direction A1 while the waste liquid recovery section 4 slides with respect to the inclined surface section 94 and presses the waste liquid recovery section 4. In other words, the recording device 1B of the present embodiment includes the restriction section 9B that restricts the movement of the waste liquid recovery section 4 in the removal direction A1, and the restriction section 9B includes the inclined surface section 94 as a pressing section that is configured to press the waste liquid recovery section 4 in the fixing direction A2 opposite to the removal direction A1. With such a configuration, it is possible to suppress the waste liquid recovery section 4 from moving in the removal direction A1 in a state where the scanner unit 6A is in the closed position. It should be noted that the pressing section of the present embodiment is the inclined surface section 94, but the pressing section is not limited to such a configuration, and for example, a plate spring or the like may be provided as the pressing section.

Similarly to the recording device 1A of the first embodiment, as illustrated in FIGS. 14 to 20, the recording device 1B of the present embodiment also includes, on the scanner unit 6A, positioning sections 11A and 11B having a protruding shape that perform positioning in the first direction A with respect to the housing 5, and includes, on the housing 5, the positioned sections 12A and 12B having a recessed shape into which the positioning sections 11A and 11B enter in a state where the scanner unit 6A is located in the closed position. The positioning sections 11A and 11B are located closer to the distal end 63 than the movement region R1 illustrated in FIG. 15 in the +Y direction from the proximal end 62 side toward the distal end 63 side in a case where the scanner unit 6A is located in the closed position. With such a configuration, it is possible to reduce wobbling of the scanner unit 6A with respect to the housing 5 due to variation in the positional relationship between the scanner unit 6A and the housing 5. In the present embodiment, similarly to the first embodiment, the positioning sections 11 that have the protruding shape are provided on the scanner unit 6A, and the positioned sections 12 that have the recessed shape are provided on the housing 5, but the present embodiment is not limited to such a configuration, and the positioning sections 11 that have the recessed shape may be provided on the scanner unit 6A, and the positioned sections 12 that have a protruding shape may be provided on the housing 5.

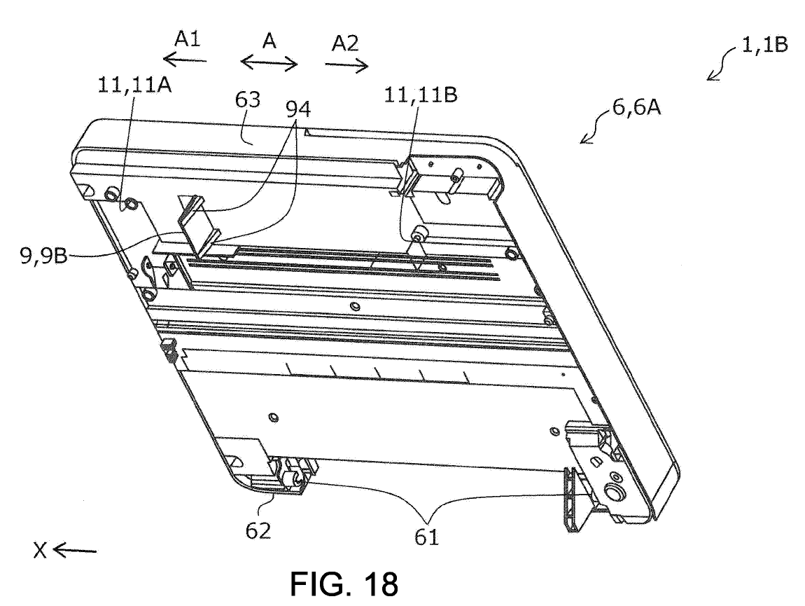

It should be noted that as illustrated in FIG. 18, when viewed from the first direction A, the positioning sections 11A and 11B are disposed at positions overlapping the restriction section 9B. Therefore, in a state where the scanner unit 6A is located in the closed position, the positioned sections 12A and 12B are also disposed at positions overlapping the restriction section 9B when viewed from the first direction A. With such a configuration, it is possible to reduce the area occupied by the positioned sections 12A and 12B and the restriction section 9B when viewed from the first direction A, and it is possible to suitably reduce the size of the recording device 1.

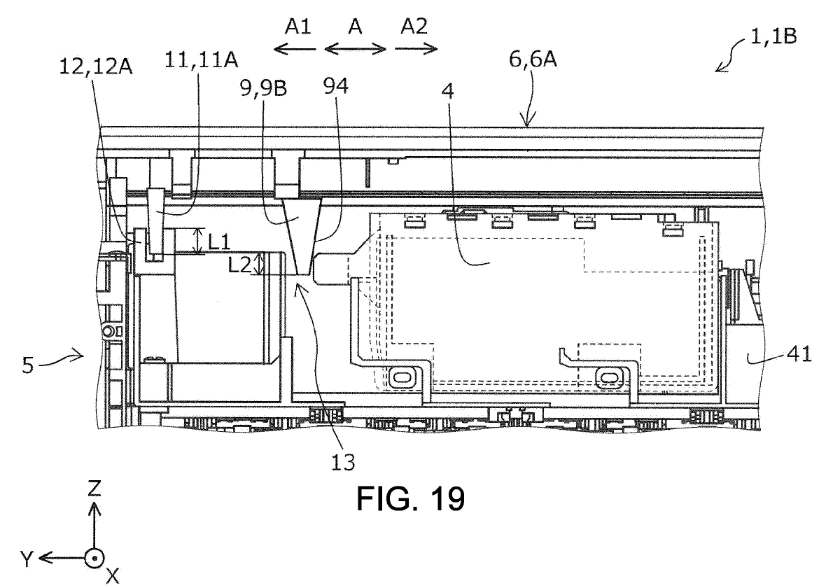

As illustrated in FIGS. 19 and 20, in the recording device 1B of the present embodiment, the housing 5 includes the positioned sections 12, which have a recessed shape, into which the positioning sections 11, which have a protruding shape, enter in a state where the scanner unit 6A is located in the closed position, and a restriction section holding section 13, which has a recessed shape, into which the restriction section 9B, which has a protruding shape, enters in a state where the scanner unit 6A is located in the closed position. In the recording device 1B of the present embodiment, as illustrated in FIG. 19, a first length L1, which is a length in which the positioned section 12A of the positioned sections 12 and the positioning section 11A of the positioning sections 11 overlap each other when viewed from the first direction A, is configured to be longer than a second length L2, which is a length in which the restriction section holding section 13 and the restriction section 9B overlap each other when viewed from the first direction A. It should be noted that although not illustrated in the drawings, the length of overlap between the positioned section 12B of the positioned sections 12 and the positioning section 11B of the positioning sections 11 when viewed from the first direction A is also longer than the second length L2, which is the length of overlap between the restriction section holding section 13 and the restriction section 9B when viewed from the first direction A. With such a configuration, the positioning of the restriction section holding section 13 and the restriction section 9B can be particularly suitably performed, and the variation in the positional relationship between the restriction section 9B and the waste liquid recovery section 4 can be suitably reduced.

As illustrated in FIGS. 19 and 20, in the recording device 1B according to the present embodiment, the positioned section 12A is provided on the upward direction side (+Z direction side) of the restriction section holding section 13. That is, the recording device 1B of the present embodiment is configured such that, as the scanner unit 6A moves from the opened position to the closed position, the positioning section 11A starts to enter the positioned section 12A, and thereafter the restriction section 9B starts to enter the restriction section holding section 13. It should be noted that although not illustrated in the drawings, the recording device 1B of the present embodiment is configured such that, as the scanner unit 6A moves from the opened position to the closed position, the positioning section 11B starts to enter the positioned section 12B, and thereafter the restriction section 9B starts to enter the restriction section holding section 13. With this configuration, the positioning sections 11 are positioned by first coming into contact with the positioned sections 12, and thus it is possible to suitably reduce a variation in the positional relationship between the restriction section 9B and the waste liquid recovery section 4.

### THIRD EMBODIMENT

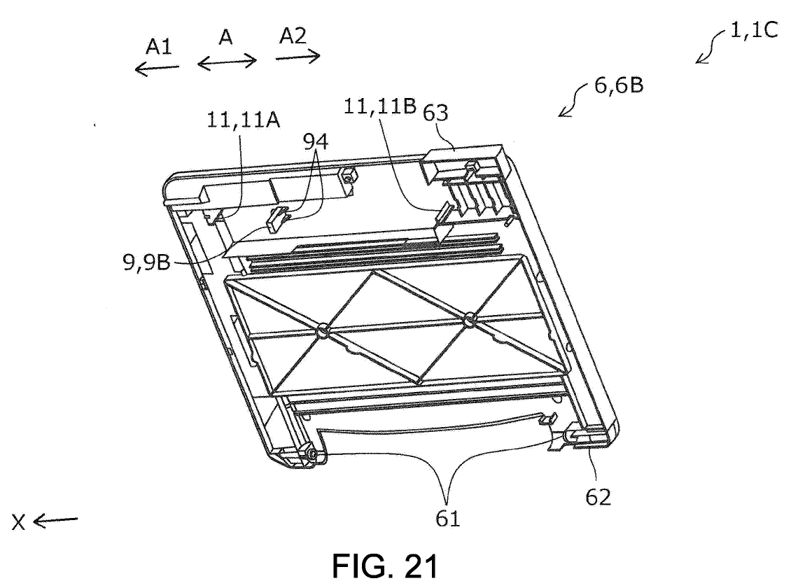

Next, a recording device 1C of a third embodiment will be described with reference to FIG. 21. FIG. 21 corresponds to FIG. 18 of the recording device 1B of the second embodiment. It should be noted that in FIG. 18, the same reference numerals are given to the same constituent member as those in the first and second embodiments, and the detailed description thereof will be omitted. Here, the recording device 1C of the present embodiment has the same configuration as the recording device 1B of the second embodiment except for the configuration of the opening and closing body 6. Therefore, the recording device 1C of the present embodiment has the same characteristics as the recording device 1 of the first and second embodiments, except for the portions described below.

As described above, in the recording device 1 of the first and second embodiments, the opening and closing body 6 corresponds to the scanner unit 6A. On the other hand, the recording device 1C of the present embodiment does not include the scanner unit 6A, and the opening and closing body 6 corresponds to an upper cover 6B that is a part of the exterior covering the upper surface of the housing 5. As described above, the configuration of the opening and closing body 6 is not particularly limited. The opening and closing body 6 may be a unit having a function different from the operation panel or the scanner unit 6A.

The present disclosure is not limited to the embodiments and the modifications described above, and various modifications are possible within the scope of the disclosure described in the claims, and it is needless to say that they are also included within the scope of the present disclosure. For example, the removal direction A1 and the fixing direction

A2, which are movement directions of the waste liquid recovery section 4, which is a liquid container, with respect to the housing 5, may not be directions along the X-axis direction. The liquid container may not be the waste liquid recovery section 4 such as a waste ink tank, a waste ink cart cartridge, or a waste ink pack, and may be, for example, an ink tank, an ink cartridge, or an ink pack of ink used for recording. The ink container may be an ink tank, an ink cartridge, an ink pack, and may be capable of storing both ink used for printing and waste liquid (waste ink).

What is claimed is:

1. A recording device comprising:
a recording section that is configured to perform recording on a medium by moving in a first direction in a movement region;
a liquid container that stores liquid;
a housing that is configured to accommodate the recording section and the liquid container; and
an opening and closing body that is openable and closable with respect to the housing by a distal end side thereof rotating between an opened position and a closed position with a pivot shaft having an axial direction in the first direction as a proximal end side and that covers the inside of the housing while in the closed position, wherein
the liquid container is configured to be removable by being slid with respect to the housing in a removal direction along the first direction,
the opening and closing body includes a support section that supports the opening and closing body in the opened position,
when the opening and closing body is located in the closed position, the liquid container overlaps the support section when viewed from the first direction, and
when the opening and closing body is located in the closed position, the recording section does not overlap the support section when viewed from the first direction.

2. The recording device according to claim 1, wherein
the support section is located further to the distal end side than the movement region in a direction from the proximal end side toward the distal end side when the opening and closing body is located in the closed position.

3. The recording device according to claim 1, wherein
the housing includes a restriction section that is provided so as to be movable to a restriction position and a nonrestriction position and that restricts movement of the liquid container in the removal direction while in the restriction position,
the opening and closing body includes a protruding section that is contactable with the restriction section, and
the restriction section is pushed by the protruding section and moves to the restriction position when the opening and closing body moves from the opened position to the closed position.

4. The recording device according to claim 3, wherein
the protruding section fixes the restriction section in the restriction position by contacting the restriction section in a state where the opening and closing body is located in the closed position.

5. The recording device according to claim 3, wherein
when the opening and closing body moves from the opened position to the closed position, the restriction section presses the liquid container in a fixing direction opposite to the removal direction.

6. The recording device according to claim 1, wherein
the opening and closing body includes a restriction section that restricts movement of the liquid container in the removal direction in the closed position.

7. The recording device according to claim 6, wherein
the restriction section comes into contact with the liquid container in a state in which the opening and closing body is in an intermediate state accompanying movement from the opened position to the closed position, and moves the liquid container in a fixing direction opposite to the removal direction while pressing the liquid container as the opening and closing body moves to the closed position while coming into contact with the liquid container.

8. The recording device according to claim 1, further comprising:
a restriction section configured to restrict movement of the liquid container in the removal direction, wherein
the restriction section includes a pressing section that is configured to press the liquid container in a fixing direction opposite to the removal direction.

9. The recording device according to claim 1, wherein
the opening and closing body includes a positioning section configured to perform positioning in the first direction with respect to the housing,
the housing includes a positioned section configured to be fitted into the positioning section when the opening and closing body is located in the closed position, and
the positioned section is positioned further to the distal end side than the movement region in a direction from the proximal end side toward the distal end side when the opening and closing body is positioned in the closed position.

10. The recording device according to claim 9, further comprising:
a restriction section configured to restrict movement of the liquid container in the removal direction, wherein
the positioned section overlaps the restriction section when viewed from the first direction.

11. The recording device according to claim 10, wherein
the housing includes a restriction section holding section that has a recessed shape into which the restriction section having a protruding shape is configured to enter when the opening and closing body is located in the closed position and
a first length, which is a length by which the positioned holding section and the positioning section overlap each other when viewed from the first direction, is longer than a second length, which is a length by which the restriction section holding section and the restriction section overlap each other when viewed from the first direction.

12. The recording device according to claim 10, wherein
the housing includes a restriction section holding section that has a recessed shape into which the restriction section having a protruding shape is configured to enter when the opening and closing body is located in the closed position and
the opening and closing body is configured such that, as the opening and closing body moves from the opened position to the closed position, the restriction section enters the restriction section holding section after the positioning section starts to enter the positioned section.

13. The recording device according to claim 1, wherein
the liquid container is configured to enter a support section holding region, in which the support section is located when the opening and closing body is located in the closed position, by being slid in the removal direction in accordance with movement of the opening and closing body from the closed position to the opened position and with movement of the support section from the support section holding region.

14. The recording device according to claim 1, wherein
the liquid container is a waste liquid recovery section,
the housing includes an insertion section that is inserted into the waste liquid recovery section, and
the insertion section is inserted into the waste liquid recovery section as the opening and closing body is moved from the opened position to the closed position.
